(19) United States
(12) Patent Application Publication
(10) Pub. No.: US 2004/0128260 A1
(43) Pub. Date: Jul. 1, 2004

(54) Method and system for protecting against unauthorized modification of products

(75) Inventors: Jeannie Amedure, Billerica, MA (US); Tieliang Cao, Acton, MA (US); Antero Diniz, Assonet, MA (US); Chris Hahn, Stoneham, MA (US); Joseph Horvath, Groton, MA (US); Michael Frechette, Nashua, NH (US); Garret White, Pelham, NH (US)

Correspondence Address: BANNER & WITCOFF, 1001 G STREET N W, SUITE 1100, WASHINGTON, DC, 20001, US

(73) Assignee: NOKIA, Inc.

(21) Appl. No.: 10/330,683

(22) Filed: Dec. 30, 2002

(51) Int. Cl. G06F 17/60

(52) U.S. Cl. 705/75

(57) ABSTRACT

A method and system for protecting against unauthorized modification of a product to enhance its performance or function are disclosed. Low end products that are part of an electronic product family can be safeguarded against unauthorized enhancement of the product by hardware, software, and firmware bypasses. The operating software of the products can detect the unauthorized modification of the product or input/output device connecting to the product by reading the unique product group ID code and determining the validity of the code. Other background measures including hardware and firmware safeguards can be used to hinder or prevent the unauthorized modification. Other product specific information data can also be used to verify that the product group ID code has not been modified in an attempt to bypass the software safeguard.

### FIELD OF THE INVENTION

The invention relates generally to protection of devices from unauthorized modifications to alter performance. More specifically, the invention relates to protecting product differentiation in electronic product families by enforcing product characteristics through hardware, software, and firmware, thus preventing changes in component speed or performance.

### BACKGROUND OF THE INVENTION

As the computer industry spans deeper into global society, the need for faster performance and quicker results have followed suit. In late 1992, many manufacturers of personal computers were selling desktop computers with processor speeds reaching 33 MHz. Today, personal computers are being sold reaching processor speeds in excess of 3 GHz. Yet, the advancement in speed and performance of electronic products has not come without a price. Faster machines are typically more expensive that their slower counterparts.

Initially, manufacturers for electronic equipment developed independent products for each project. That is, although the system performance of one computer to another might only be a faster bus speed or different input/output (I/O) component, computer circuit boards typically were developed and manufactured differently and independently for each product. This delineation of products ensured that unauthorized modification of a product to attempt to enhance its performance was minimized. However, development of multiple unique products cost more and required a longer time-to-market than development of a common platform that allowed differentiated products. Manufacturers of electronic devices soon began to develop electronic product families, where each product in the family shares a common feature or features with other products in the family. Differences between products in the family typically include hardware components or processor speed, software, or firmware versions; however, a common platform between the electronic products exists. In many cases, an electronic product family is a group of products serving a similar goal and manufactured on duplicate electrical platforms, such as a motherboard or other circuit board in relation to computers.

One such example of an electronic product family is a family of desktop computers. Anyone can go onto the Internet and search for a personal desktop computer to buy from a particular manufacturer. Many manufactures of computers, just as with automobile manufacturers, offer a base line model with certain standard features. Then, an individual can pick and choose certain features to add-on, remove, or revise. Some of these features include the internal hard drive capacity, the front-end bus speed, and the system processor speed. Manufactures are selling computers that are structurally equivalent to one another, except for certain hardware, software, or firmware differences. Manufacturing costs are reduced as a common platform is produced for all of the products in the family and only then are the necessary differing components later incorporated into each particular product. Further, because of the commonality of the products, development resources can be leveraged to produce two or more products within the same time frame, but at reduced cost, thus providing more product choice to consumers. Quality control checks can be minimized further decreasing development time and overall cost in design and research.

When a common platform is incorporated into many different products, however, a user might modify a lower-end product to enhance the performance of the product to be equivalent to a higher-end product, but without the expense of paying for it. Products within one electronic product family can have significant differences in prices. This substantial cost difference may tempt customers and field service personal to modify one baseline product in the family into a higher end product in the family of electronic products. Without appropriate precautions and protective measures, the similarity based on the common platform could make it simple for a user or field service personnel to perform the modification.

Manufacturers are forced to balance the savings acquired in producing base platforms for different products in the same electronic product family against the cost of protecting against unauthorized modifications. Thus, it would be an advancement in the art to provide cost effective protective measures for guarding against an unauthorized modification of a low end product in a product family that shares common characteristics. An advancement is also needed to protect electronic product families from possible unauthorized modification by incorporating hardware, software, and/or firmware safeguards together to minimize the possibility of these unauthorized modifications. Additional features are needed to protect these products while minimizing the overall production or development cost for manufacturers as well.

### SUMMARY OF THE INVENTION

To overcome limitations in the prior art described above, and to overcome other limitations that will be apparent upon reading and understanding the present specification, the present invention provides protection against an unauthorized modification of a product.

A first aspect of the invention uses a combination of hardware assembly options to prevent a product from being upgraded to an unauthorized enhanced product. Although each product in the electronic product family utilizes a common platform, different component assemblies differentiate the products. Differences in the bill-of-materials during assembly of the product produce multiple products with sufficient feature and capability differences while maintaining a common consumer “look and feel” and a common manufacturing process.

A second aspect of the invention allows the operating software for the product to enable or disable certain features and functions by accessing a unique product group ID code that is contained within the product memory or particular input/output device attempting to be connected to the product.

Another aspect of the invention uses firmware versions contained within programmable logic devices to prevent unauthorized personnel from enhancing the performance of a product. For example, the firmware versions can determine the data rates that the plug-in cards can operate, the processor bus speed, control signals, and the memory size. Because operation of the product is limited to the data rates and processing speeds allowed by the firmware, individuals cannot simply populate additional components to update the product and increase performance, nor can the individual bypass the product group ID code.

Other methods and systems may also be used for verifying the authenticity of a unique product group ID code of a product or I/O device being connected to the product. The product serial number or some other form of product specific information data and the product group ID code can be compared against a software memory table to determine whether the product serial number falls within an allowable range for the product group ID code. Therefore, even if someone has tampered with a low end product group ID code field to populate it with data representative of a high end product, the product can detect the modification and operate accordingly.

### DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 is a block diagram illustrating two products within an electronic product family according to an illustrative embodiment of the invention;

FIG. 2 illustrates data fields stored in memory according to an illustrative embodiment of the invention;

FIG. 3 illustrates a method of protecting against unauthorized modification of a product according to an illustrative embodiment of the invention;

FIG. 4 illustrates a method of protecting against unauthorized modification of a product when a new device is connected to a product according to an illustrative embodiment of the invention;

FIG. 5 illustrates a method of protecting against unauthorized modification of a low end product according to an illustrative embodiment of the invention;

FIG. 6 illustrates a method of protecting against unauthorized modification of a low end product according to an illustrative embodiment of the invention;

FIG. 7 illustrates a method of protecting against unauthorized modification of a low end product according to an illustrative embodiment of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

Aspects of the present invention combine the advantages of different forms of unauthorized modification detection for enforcing and maintaining differentiation of products within an electronic product family. An electronic product family refers to a multiple number of products, from a high end product to middle level products to a low end product, that share a common feature or features, e.g., a uniform physical platform or printed circuit board. Some differences between the products can include hardware components, software, or firmware versions; however, some common platform between the electronic products exists. Using the present invention, product differentiation can be protected from unauthorized modification. Low end products in an electronic product family are not so easily modifiable to allow for enhanced performance of the low end product beyond authorized allowances.

A first mechanism that may be used to protect the differentiation of products in an electronic product family is the use of hardware differentiation. For example, in cases where a higher end product utilizes a different I/O option compared to a lower end product, manufacturers may included necessary hardware components to the higher end products. Although deterring some individuals, these same hardware components often can be obtained at an electronics store and simply soldered onto the circuit board of a lower end product to permit the same connection for the particular I/O option, thus in a preferred embodiment hardware safeguards are used in conjunction with one or more of software and firmware safeguards, as further described below.

A second mechanism that may be used to deter modification of a product to enhance performance is the use of differentiated software. Although multiple products within the same electronic product family might have a common circuit board platform, lower end products in the family may operate according to a different software package than higher end products in the same family. However, manufactures might then be left to develop separate and independent software packages to protect and operate each product in the family. Thus, a single software package that can be used in all products within an electronic product family while maintaining differentiation between the products may be used. For example, the software may determine a product type by a particular product group identification (ID) code, and provide software functionality based on the product group ID code. Upon initiation of an electronic product, software will access a product group identification code embedded within the device. This code will determine which features of the product family that should be enabled or disabled for operation of the particular product. However, modification of the product group ID code might allow an individual to gain access to all of the features of a higher end product in the product family. Thus, in a preferred embodiment, software safeguards are used in conjunction with one or more of hardware and firmware safeguards, as further described below.

A third mechanism to protect against unauthorized modification of products includes the use of different versions of firmware. Certain parameters for product operation may be defined by a firmware version embedded within the product. For example, data bus widths and memory capabilities may be defined by a particular version of firmware. The firmware version for a lower end product may affect the behavior of certain control signals for operation of the electronic device in one fashion while a different firmware version for a higher end product may affect the behavior of the same control signals for operation of the electronic device in a different fashion. Firmware versions can be incorporated into a device to minimize or maximize the operational speed of a particular programmable logic device. Even if an individual were to modify the hardware components of a product, the firmware would decrease the intended performance of the unauthorized modification. For example, an individual might alter a lower end product by connecting an I/O option with a predefined operating speed. However, the firmware version embedded in the product would restrict the I/O option to a slower predetermined speed. However, although slower in performance, the features of the higher end products may still be enabled, allowing an individual to accept the firmware version with only the slight inconvenience of a slower operating speed for some features. Thus, in a preferred embodiment, firmware safeguards are used in conjunction with one or more of hardware and software safeguards, as further described below.

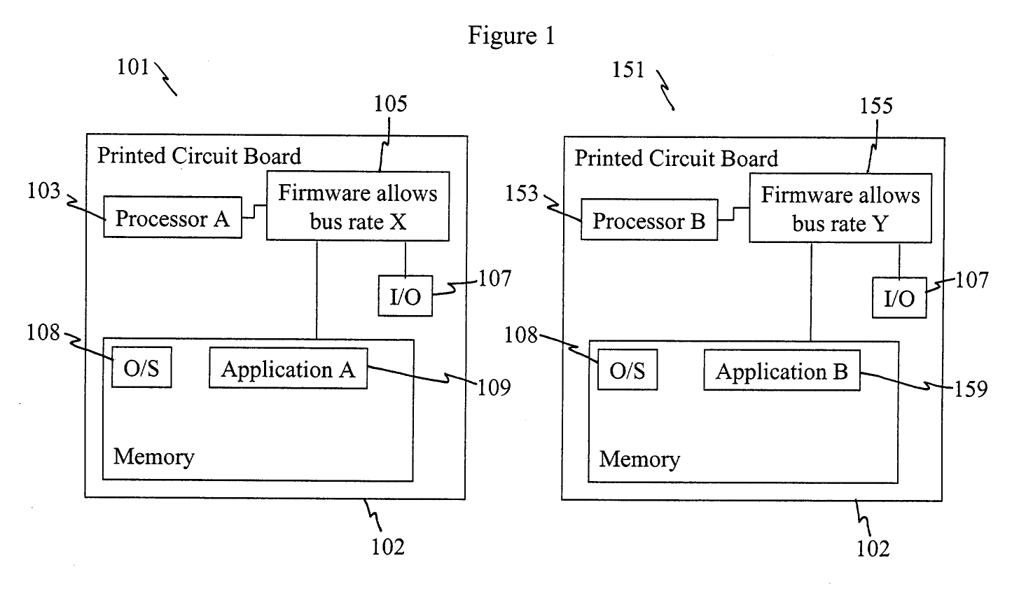

FIG. 1 is a block diagram illustrating two products within an electronic product family according to an illustrative embodiment of the invention. An electronic product family may include any of a number of products. Two are merely being shown for illustrative purposes. Products 101 and 151 have a common platform. In this example, products 101 and 151 have a common printed circuit board (PCB) 102. The printed circuit board (PCB) 102 can be produced in mass since it is included in both the low end product, i.e., product 101, and the high end product, i.e., 151. Further common elements between the two products 101 and 151 might include an input/output device or connection 107, and operating software 108. Product differentiation between product 101 and product 151 includes different system processors. In FIG. 1, product 101 has a processor A 103, while product B151 has a processor B 153. Processor B could be a faster processor that may be included in a higher end product within the same electronic product family. Further, product 101 includes application A 109 for use with operating software 108, while product 151 includes application B 159 for use with the common operating software 108. In this case, application B 159 may include additional functions beyond those included in application A 109. Finally, product 101 may include programmable logic devices (not shown) that have a firmware version stored therein allowing for a system bus rate of X. Alternatively, product 151 may include programmable logic device (not shown) that have a firmware version stored therein allowing for a system bus rate of Y. Therefore, product 151 could have a faster bus rate Y than product 101 operating with a bus rate X.

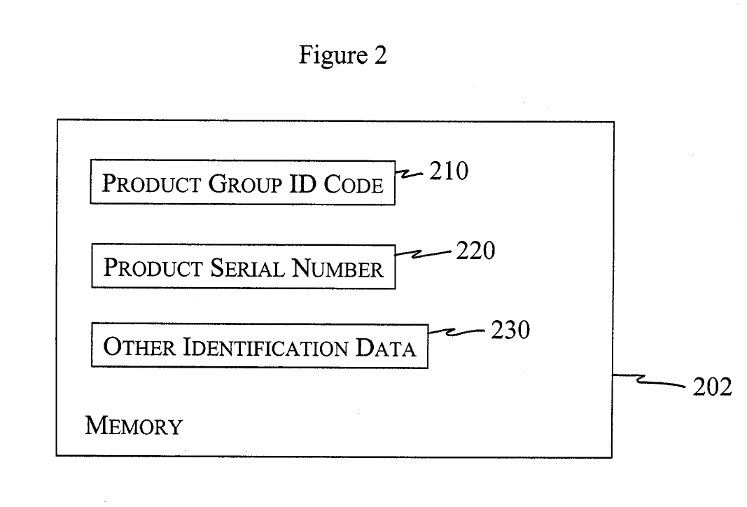

Referring to FIG. 2, a memory 202 is shown with data fields stored therein. The memory 202 may be an internal or external memory, a read only memory (ROM), an electronically erasable programmable read only memory (EEPROM), a system management serial programmable read only memory, or some other form of memory. The memory 202 may include data fields for a Product Group ID Code 210, a Product Serial Number 220, and Other Identification Data 230. A Product Group ID Code 210 is a data field that identifies a product with a particular set of features or functionalities, and can be used to distinguish products in the same family. For example, a Product Group ID Code 210 may comprise a four-bit data field, where a low end product has a unique Product Group ID Code 210 of 0000. In contrast, the Product Group ID Code for a high end product in the same electronic product family may have a unique Product Group ID Code of 1010. This example of the Product Group ID Code 210 is only one possibility of the data field. The present invention is not so limited to a particular field length or format.

A Product Serial Number 220 is a data field that is unique to each product within an electronic product family. A Product Serial Number 220 can identify a particular product from a group of high end products, middle level products, etc., each with the same functionality and features. Further, a Product Serial Number 220 can be used to verify the authenticity of a Product Group ID Code 210. In the event that an individual is able to modify the Product Group ID Code 210 of a low end product to make it appear to be a high end product, the Product Serial Number 220 can be used to verify that the Product Group ID Code 210 matches up with the Product Serial Number 220, thereby ensuring that an unauthorized modification of the product has not occurred.

A Product Serial Number 220 may correspond to a Product Group ID Code 210. A table stored in the product can store a range or set of valid serial numbers that are correlated to a particular Product Group ID Code 210. Alternatively, the Product Serial Number 220 could be a function of the Product Group ID Code 210. The valid serial numbers that correspond to the Product Group ID Code 210 may be a function requiring an output of an integer. The Product Serial Number 220 may be an input for the function where a valid Product Serial Number 220 inputted into the function will output an integer. Such are but a few examples of how the Product Group ID Code 210 and Product Serial Number 220 may correlate to one another. As used herein in the present invention, the term product information data includes a product group ID code and product specific information data, such as a product serial number or other type of product identification.

The Other Identification Data 230 is similar in function to the Product Serial Number 220. Other Identification Data 230 can be any type of information used to identify a particular product and used to verify that a Product Group ID Code 210 has not been tampered with or modified.

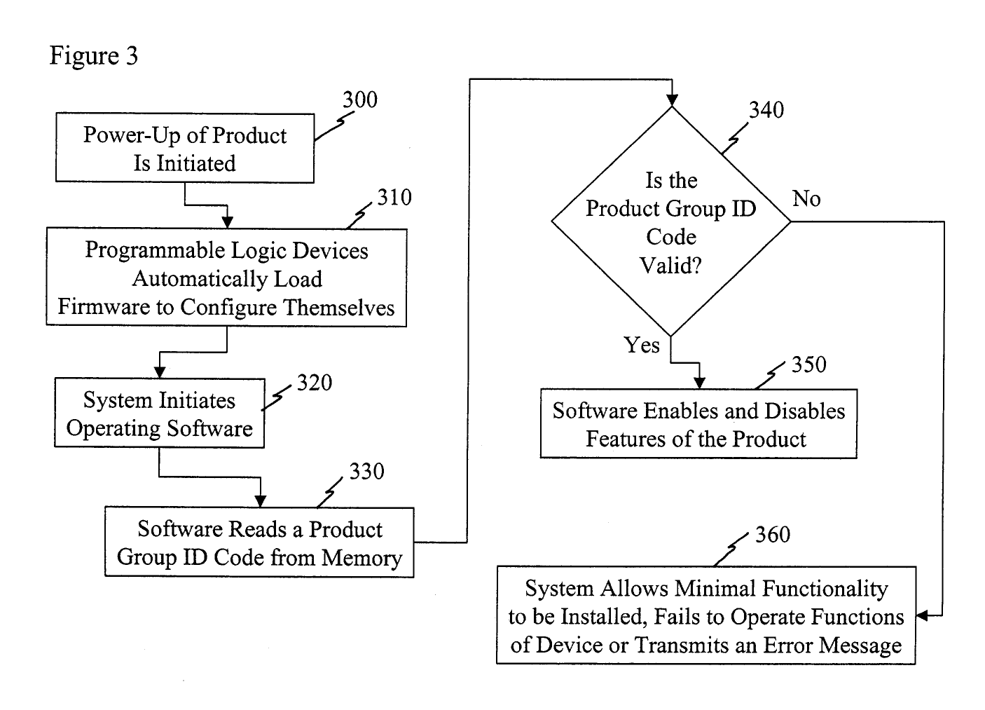

A general method of protecting against unauthorized modification of a product according to an illustrative embodiment of the invention will be described with further reference to FIG. 3, based upon the above-described features. Initially, power-up of a product is initiated at step 300. In the case of a computer, power to the computer is initiated by booting up the computer. At step 310, programmable logic devices (PLD), for example, Field Programmable Gate Arrays, automatically load firmware embedded within or associated with the PLDs to configure themselves for system operation of the product. The programmable logic device may be interconnected with a common platform included in all products within an electronic product family. The operating software for the product is then initiated by the system at step 320. It should be understood by those skilled in the art that the preceding steps are just one example of steps taken during the power-up sequence of a product. Forthcoming steps may be incorporated during operation of the product and need not be defined as occurring only after an initial power-up sequence. At step 330, the software reads the product group ID code, such as Product Group ID Code 210, from memory. The software determines the necessary functions to enable or disable in the product based upon the product group ID code. Different product group ID codes may correlate to different functions that a product has been permitted to perform by a manufacturer.

Once the software has read the product group ID code, a determination is made at step 340 as to whether the product group ID code is valid to any of the products, whether high end, low end, or somewhere designated in between. If the product group ID code is determined to be invalid, that is as not correlating to any known product group ID code found in the table, such as a software memory table (not shown), at step 360, the system will only allow minimal functions or features to be installed, fail to operate any function or feature of the product and/or transmit an error message to the operator of the product. Alternatively, if the software determines that the product group ID code is valid, the software will enable or disable the functionality or features of the product accordingly. By way of this example, the system can choose to disable the entire function of the product to hinder further modification or simply allow for minimal use of the product based upon some standard functionality or features common to all products in the electronic product family. These features can be in the form of plug-in cards, processing algorithms, or licensed 3^{rd} party application software to name a few. The software differences also may determine what plug-in cards are accepted for operation by the product. FIG. 3 illustrates an example of a product group ID code being utilized to protect against modification of a product. However, a product serial number or other identification data, such as that in FIG. 2, can be used to protect against modification of a product in the same fashion as a product group ID code.

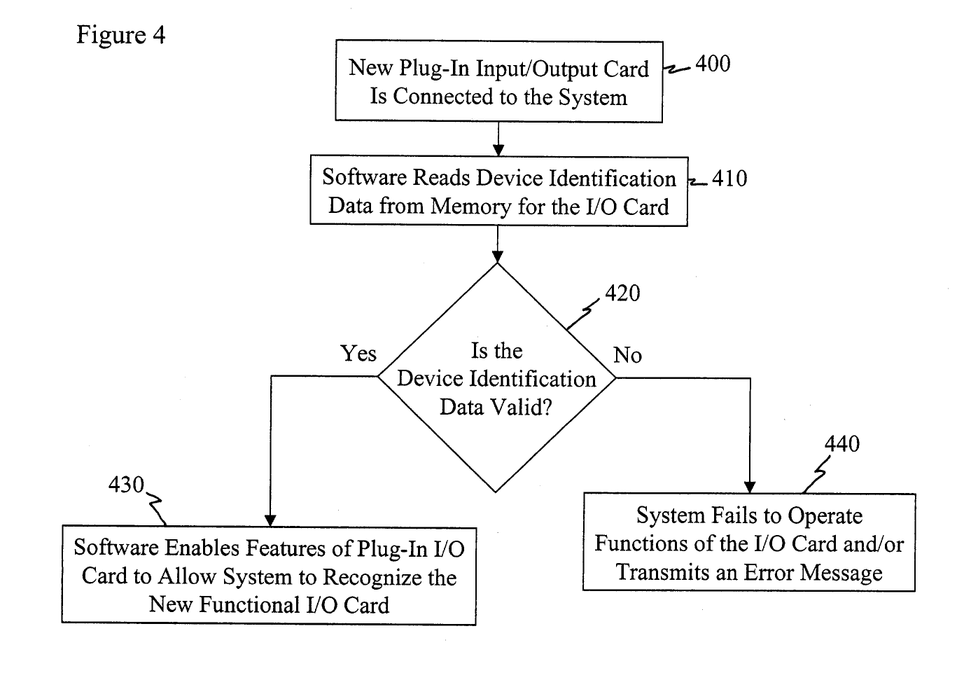

FIG. 4 illustrates a method of protecting against unauthorized modification of a product when new hardware is added to a product according to an illustrative embodiment of the invention. FIG. 4 illustrates an example of a case in which a new input/output card is connected to a product; however, this is just for illustrative purposes and the invention is not limited to the example given. At step 400, a new plug-in input/output (I/O) card is connected to the system. This step could also involve a new device being connected to the system or a new feature of the device being loaded onto the system. At step 410, the software reads device identification data from memory for the I/O card. Each I/O card is configured to have device identification data and could be configured to include a device serial number and/or other identification data similar to that shown in FIG. 2. At step 420, a determination is made by the software as to whether the device identification data for the I/O card is valid, meaning that the device identification data for the I/O card correlates to known data found within a software memory table. If the device identification data for the I/O card is found to be valid, at step 430, the software enables the features of the plug-in I/O card to allow the system to recognize the new functional I/O device. If the device identification data of the I/O card is found to be invalid, such as when an individual attempts to attach the I/O card (or other hardware) to a device not authorized to interface with that I/O card (or other hardware), the system will fail to operate the new functions of the I/O device and/or will transmit an error message to the operator.

Hardware safeguards can be included in a high end, low end, or middle level product to differentiate it from other level products. Hardware safeguards can comprise certain combinations of hardware components that may be designed for simple attachment of an authorized plug-in device. In combinations with software and firmware safeguards, these hardware safeguards can help to deter or hinder unauthorized modification. In some cases, it may be as simple as a necessary connector being omitted from the printed circuit board common to all products. In others, a circuit may be closed when necessary to be left open for enhanced performance. A number of different combinations can be utilized to minimize unauthorized modification. However, hardware safeguards alone often fail to hinder tampering of products. As such, bypasses around hardware component differences are most easily obtained compared to software and firmware differences.

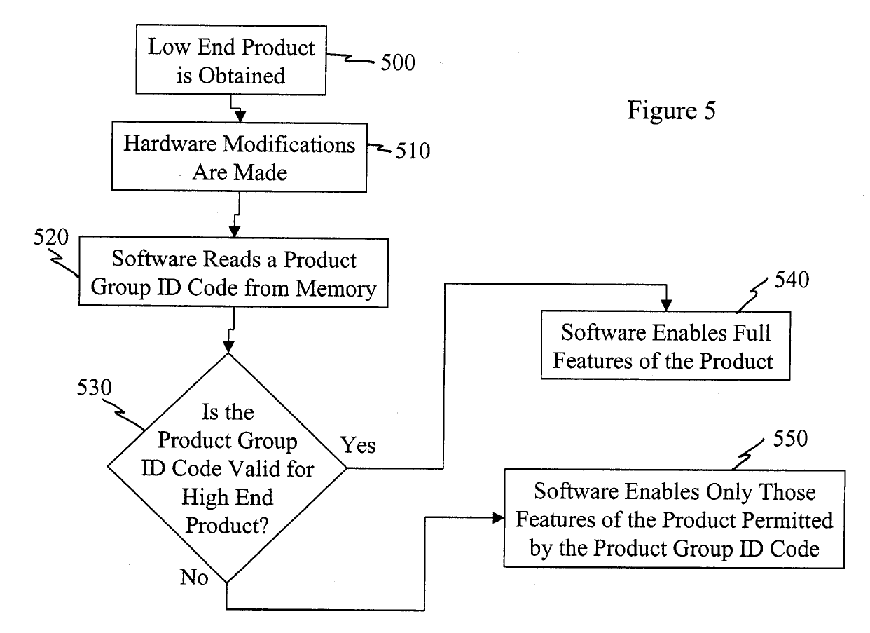

FIG. 5 illustrates a method for protecting against an unauthorized modification to a device. Initially, a low end product is obtained at step 500. At step 510, unauthorized hardware modifications are made to successfully bypass the hardware safeguard between the low end product and a higher end product. For example, the low end product could be a personal computer with system memory supported up to 512 MB. At step 510, an individual removes the memory module of 512 MB and replaces it with a high end product memory module having a capacity of 1024 MB. At step 520, the software reads a product group ID code from memory for the product. Once the software has read the product group ID code, a determination is made at step 530 as to whether the product group ID code is valid to the high end product. If the product group ID code is determined to be invalid, that is as not correlating to a high end product, at step 550, the system will only enable those functions or features permitted by the product group ID code. That is, if the product group ID code is valid for a low end product, 512 MB is allowed. Alternatively, if the software determines that the product group ID code is valid, at step 540, the software will enable or disable the full functions or features of the product accordingly. Therefore, in this case, an individual that has been able to successfully bypass the hardware safeguard is still not able to operate the product with enhanced performance capabilities.

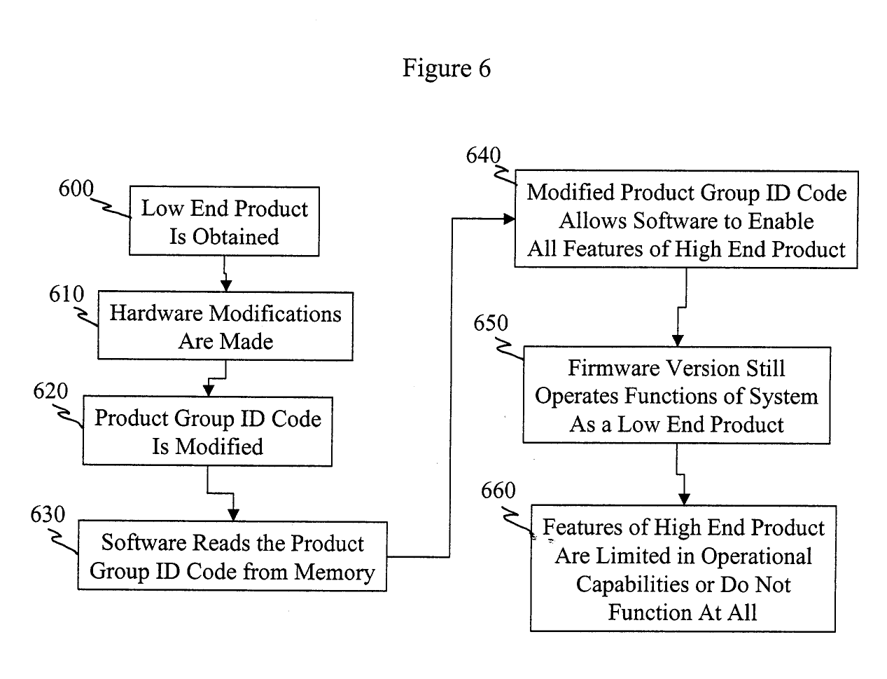

FIG. 6 illustrates another method for protecting against an unauthorized modification to a device. Initially, a low end product is obtained at step 600. At step 610, hardware modifications are made to successfully bypass the hardware safeguard between the low end product and a higher end product. Further, at step 620, the product group ID code is successfully modified to reflect the product group ID code of a high end product. This example illustrates a highly unlikely scenario in which an individual has successfully modified the hardware to reflect a high end product capability and the product group ID code of the low end product to appear as a high end product. At step 630, the software reads the modified product group ID code from memory. Because the modified product group ID code is a valid code within a software memory table, the software enables all of the features and functions of the high end product capability for the low end product at step 640.

Normally, hardware safeguards would help to prevent such an unauthorized modification; however, in this case, hardware modifications are made in step 610. Yet, at step 650, the firmware version loaded into the programmable logic devices still operates the functions of the system based upon the firmware version associated with the low end product. For example, I/O slots may be configured to support two 32-bit, 33 MHz option cards. The bus width may be modified by hardware changes to allow for a 64-bit bus width, and the software may recognize the product group ID code as that of a high end product; however, the firmware controls the I/O slot bus speed and it remains at 33 MHz instead of a high end product bus speed operating at 66 MHz. As such, at step 660, the features of the high end product are either limited in operational capabilities to that of a low end product or simply do not operate at all.

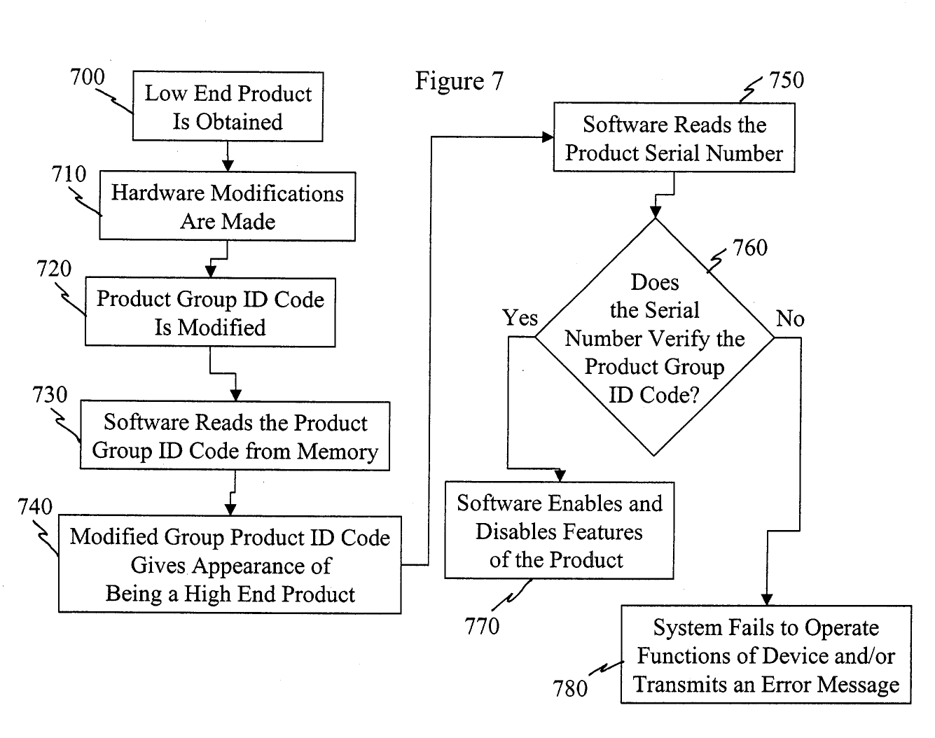

A further illustrative embodiment of the present invention is found in FIG. 7. Again, FIG. 7 illustrates a method for protecting against an unauthorized modification to a device. Initially, a low end product is obtained at step 700. At step 710, hardware modifications are made to successfully bypass the hardware safeguard between the low end product and a higher end product. Further, at step 720, the product group ID code is successfully modified to reflect the product group ID code of a high end product. Although not shown, this example could include the further step that the firmware within the programmable logic devices is modified to appear to allow enhanced performance and functionality. Therefore, this example shows a scenario in which an individual has successfully been able to bypass the hardware, software, and firmware safeguards in place.

At step 730, the software reads the modified product group ID code from memory. Because the modified product group ID code gives the appearance that the low end product is actually a high end product, the software believes that the low end product is a high end product. However, a further safeguard is invoked. At step 750, the software reads the product serial number from memory. The software could alternatively read some other identification data such as that shown in FIG. 2. Once the product serial number is read in step 750, the software compares the product serial number and product group ID code to a software memory table to determine whether the product group ID code has been modified at step 760. If the serial number corresponds to the product group ID code, at step 770, the software enables and disables features and functions of the product based upon the validated product group ID code. However, if the product group ID code and the product serial number do not match up correctly, at step 780, the system fails to operate the functions and features of the device and/or transmits an error message to the operator. With this safeguard in operation, hardware, software, and firmware bypasses are not enough to enable high end functionality into a low end product.

One or more aspects of the invention may be embodied in computer-executable instructions, such as in one or more program modules, executed by one or more computers, mobile terminals, access routers, or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

We claim:

1. A method for protecting against unauthorized modification of a product, comprising:
operating the product by a version of firmware specifically configured for the product;
reading product information data;
determining whether the product information data is valid; and
configuring at least one feature of the product, based on the determining step.

2. The method of claim 1, wherein product information data comprises a product group identification code.

3. The method of claim 2, wherein the product group identification code is stored in memory.

4. The method of claim 3, wherein the product group identification code comprises a data field that corresponds to the product.

5. The method of claim 3, wherein the product group identification code corresponds to an input/output card.

6. The method of claim 3, wherein the memory includes product initiation code.

7. The method of claim 3, wherein the memory comprises programmable read only memory.

8. The method of claim 1, wherein product information data comprises product specific information data.

9. The method of claim 1, further comprising the step of configuring a common platform of the product based upon a hardware safeguard specifically configured for the product.

10. The method of claim 9, wherein the hardware safeguard defines an allowable bus width.

11. The method of claim 9, wherein the hardware safeguard comprises an exclusion of certain hardware components.

12. The method of claim 1, wherein the version of firmware defines behavior of at least one control signal.

13. The method of claim 12, wherein the at least one control signal defines a processor bus speed of the product.

14. The method of claim 12, wherein the at least one control signal defines an allowable bus speed of an input/output device.

15. The method of claim 12, wherein the at least one control signal defines an allowable memory capacity of the product.

16. The method of claim 1, wherein a programmable logic device comprises the version of firmware.

17. The method of claim 16, wherein the programmable logic device is interconnected with a common platform of the product.

18. The method of claim 1, wherein the product comprises an input/output card.

19. The method of claim 1, wherein the step of reading the product information data is performed by software.

20. The method of claim 19, wherein the software is stored within a memory of the product.

21. The method of claim 1, further comprising the step of storing a table of valid product information data.

22. The method of claim 21, wherein the table of valid product information data is stored within software.

23. The method of claim 21, wherein the step of determining whether the product information data is valid comprises:
querying the table of valid product information data against the read product information data; and
determining whether the product information data matches an entry in the table of valid product information data.

24. The method of claim 21, wherein product information data comprises a product group ID code, further comprising the steps of:
reading product specific information data from memory in the product; and
querying a table of valid product specific information data;
wherein the step of determining whether the product information data is valid comprises:
checking the table of valid product specific information data and corresponding product group identification codes against the read product group identification code and the read product specific information data; and
determining whether the product specific information data verifies the product group identification code.

25. The method of claim 24, wherein the product specific information data comprises a product serial number.

26. The method of claim 24, wherein the step of determining whether the product specific information data verifies the product group identification code comprises matching the product group identification code against a range of valid product specific information data.

27. The method of claim 1, wherein, upon determining that the product information data is valid, the step of configuring at least one feature of the product comprises enabling the at least one feature of the product according to the product information data.

28. The method of claim 27, wherein software enables and disables the at least one feature of the product according to the product information data.

29. The method of claim 1, wherein, upon determining that the product information data is invalid, the step of configuring the at least one feature of the product comprises disabling the at least one feature of the product.

30. The method of claim 29, wherein the step of configuring the at least one feature of the product further comprises transmitting an error message corresponding to the invalid product information data.

31. The method of claim 29, wherein the at least one feature of the product includes a plurality of features of the product.

32. The method of claim 29, wherein disabling the at least one feature of the product includes only features of the product not included in a lower end product in a same product family.

33. The method of claim 29, wherein disabling the at least one feature of the product is performed by a programmable logic device comprising the version of firmware.

34. The method of claim 29, wherein disabling the at least one feature of the product is performed by software stored within memory.

35. A method for protecting against unauthorized modification of a product, comprising:
reading a product group identification code;
reading product specific information data;
determining whether the product group identification code is valid;
determining whether the product specific information data is valid based on the product group identification code; and
configuring at least one feature of the product based on the determining steps.

36. The method of claim 35, further comprising the step of operating the product by a version of firmware specifically configured for the product.

37. The method of claim 36, further comprising the step of configuring a common platform of the product based upon a hardware safeguard specifically configured for the product.

38. A method for protecting against connection of an unauthorized device to a product, comprising:
operating the product by a version of firmware specifically configured for the product;
receiving device identification data from the device;
determining whether the device identification data is valid to permit connection of the device to the product; and
configuring at least one feature of the product based on the determining step.

39. The method of claim 38, further comprising:
reading a product group identification code from the product to which the device is attached;
wherein the step of determining whether the device identification data is valid to permit connection, comprises:
querying a table of valid device identification data and corresponding product group identification codes for the read product group identification code and the read device identification data to determine whether the device identification data is valid for the read product group ID code.

40. The method of claim 39, wherein, upon determining that the device identification data is valid to permit connection of the device, the step of configuring at least one feature of the product comprises enabling the product to recognize the device.

41. The method of claim 39, wherein upon determining that the device identification data is invalid to permit connection of the device, the step of configuring at least one feature of the product comprises failing to enable the product to recognize the device.

42. A system providing protection against unauthorized modification, comprising:
a firmware component to operate the system and configured specifically for the system; and
a software component to enable and/or disable at least one feature of the product based upon the validity of a product group identification code.

43. The system of claim 42, further comprising a hardware component configured specifically for the system.

44. The system of claim 42, wherein the software component reads the product group identification code and determines the validity of the product identification group code.

45. The system of claim 44, wherein the software component comprises a table of valid product group identification codes.

46. The system of claim 44, wherein the software component reads product specific information data to determine the validity of the product group identification code.

47. The system of claim 46, wherein the software component comprises a table of product specific information data and corresponding valid product group identification codes.
